(19) United States
(12) Patent Application Publication
(10) Pub. No.: US 2006/0233524 A1
(43) Pub. Date: Oct. 19, 2006

(54) Information management apparatus and information management method

(75) Inventor: Yoko Masuo, Iruma-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/395,277

(22) Filed: Apr. 3, 2006

(30) Foreign Application Priority Data
Apr. 19, 2005 (JP) 2005-121456

(51) Int. Cl. H04N 7/00

(52) U.S. Cl. 386/95

(57) ABSTRACT

According to one embodiment, in a system in which a server which delivers contents and receiving terminals of respective users are connected via a network, the server is configured to manage contents obtained from various media, individually for the receiving terminals of respective users. Consequently, it is possible to respond to various requests from the users at a practical level, such as each user resuming watching from a position of the previous watching end even to a same content.

### CROSS-REFERENCE TO RELATED APPLICATIONS

This application is based upon and claims the benefit of priority from Japanese Patent Applications No. 2005-121456, filed Apr. 19, 2005, the entire contents of which are incorporated herein by reference.

### BACKGROUND

1. Field

One embodiment of the invention relates to an information management apparatus and an information management method to be used preferably for a content delivery management and the like in, for example, a home network system.

2. Description of the Related Art

As is well known, in recent years, a constitution of a so-called home network system has been realized. In such a home network system, an optical disk recording/reproducing apparatus that records and reproduces information to and from an optical disk such as, for example, a digital versatile disk (DVD) is served as a home server, and contents required by the optical disk recording/reproducing apparatus are delivered according to requests from respective users.

In this case, it is required for the optical disk recording/reproducing apparatus not merely to have a function of reproducing an optical disk to obtain contents thereof, but also have a function of obtaining contents from various media and delivering them to users, such as a function of receiving television broadcasting to obtain contents thereof, and a function of downloading contents via an external network.

For this reason, in constituting the above-described home network system, it is important that the optical disk recording/reproducing apparatus serving as a home server can manage contents obtained from various media individually for each of users, and respond to detailed requests of each of the users in a quick and precise manner.

Jpn. Pat. Appln. KOKAI Publication No. 2004-96478 discloses a content delivery system using a general purpose network. The content delivery system is configured such that a content watching history service program that performs a watching history management is introduced, and the watching end time of a user's previous watching is stored as a watching history, whereby, at the user's next watching, watching can be resumed from a position where the user ended its previous watching.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram for explaining the outline of a home network system according to one embodiment of the present invention;

FIG. 2 is a block diagram for explaining a signal processing system of an optical disk recording/reproducing apparatus in the embodiment;

FIG. 3 is a diagram for explaining each database formed in a memory unit of the optical disk recording/reproducing apparatus in the embodiment;

FIG. 4 is a diagram for explaining each function of a control unit in the recording unit of the optical disk recording/reproducing apparatus in the embodiment;

FIG. 5 is a diagram for explaining a user information database formed in the memory unit of the optical disk recording/reproducing apparatus in the embodiment;

FIG. 6 is a diagram for explaining a content information database formed in the memory unit of the optical disk recording/reproducing apparatus in the embodiment;

FIG. 7 is a diagram for explaining a content watching record database formed in the memory unit of the optical disk recording/reproducing apparatus in the embodiment;

FIG. 8 is a block diagram for explaining a signal processing system of a television broadcasting receiver in the embodiment;

FIG. 9 is a diagram for explaining each function of a control unit of the television broadcasting receiver in the embodiment;

FIG. 10 is a flow chart for explaining a major processing operation in the home network system in the embodiment;

FIG. 11 is a view for explaining one example of a user ID select screen displayed during the operation of the home network system in the embodiment; and

FIG. 12 is a view for explaining one example of a content list display screen displayed during the operation of the home network system in the embodiment.

### DETAILED DESCRIPTION

Various embodiments according to the invention will be described hereinafter with reference to the accompanying drawings. In general, according to one embodiment of the invention, in a system in which a server which delivers contents and receiving terminals of respective users are connected via a network, the server is configured to manage contents obtained from various media, individually for the reviving terminals of respective users. Consequently, it is possible to respond to various requests from the users at a practical level, such as each user resuming watching from a position of the previous watching end event to a same content.

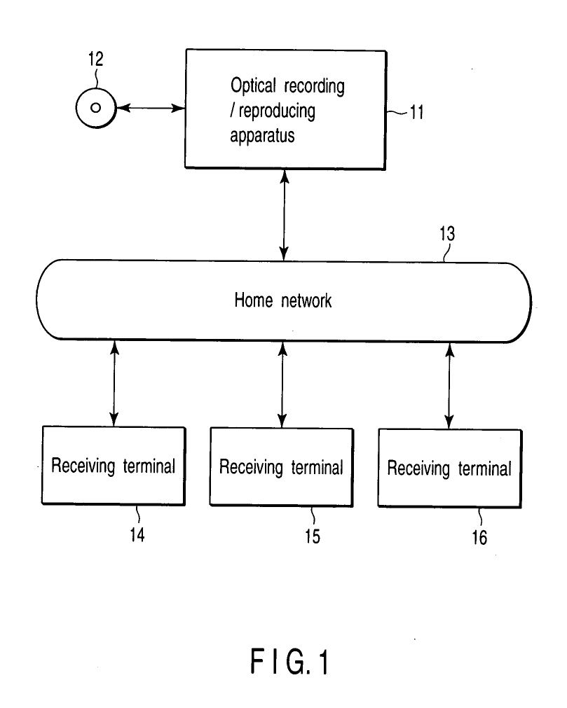

FIG. 1 shows the outline of a home network system to be explained in the present embodiment. In FIG. 1, reference numeral 11 is an optical disk recording/reproducing apparatus serving as a home server.

When an optical disk which is an information recording medium is attached to the optical disk recording/reproducing apparatus 11, the apparatus 11 can record and reproduce contents such as video and audio to and from the optical disk 12.

In this case, the optical disk recording/reproducing apparatus 11 has a function of receiving television broadcasting to obtain contents thereof, a function of obtaining contents via an external network, and the like. The optical disk recording/reproducing apparatus 11 can record contents obtained from television broadcasting and the external network, etc. to the optical disk 12.

Further, the optical disk recording/reproducing apparatus 11 can deliver contents obtained from the optical disk 12, television broadcasting and the external network, etc. via a home network 13 to a plurality (three units in the case illustrated) of receiving terminals 14, 15, 16.

As these receiving terminals 14, 15, 16, for example, a personal computer (PC), a television receiver and the like that can display video and reproduce audio according to input contents may be employed.

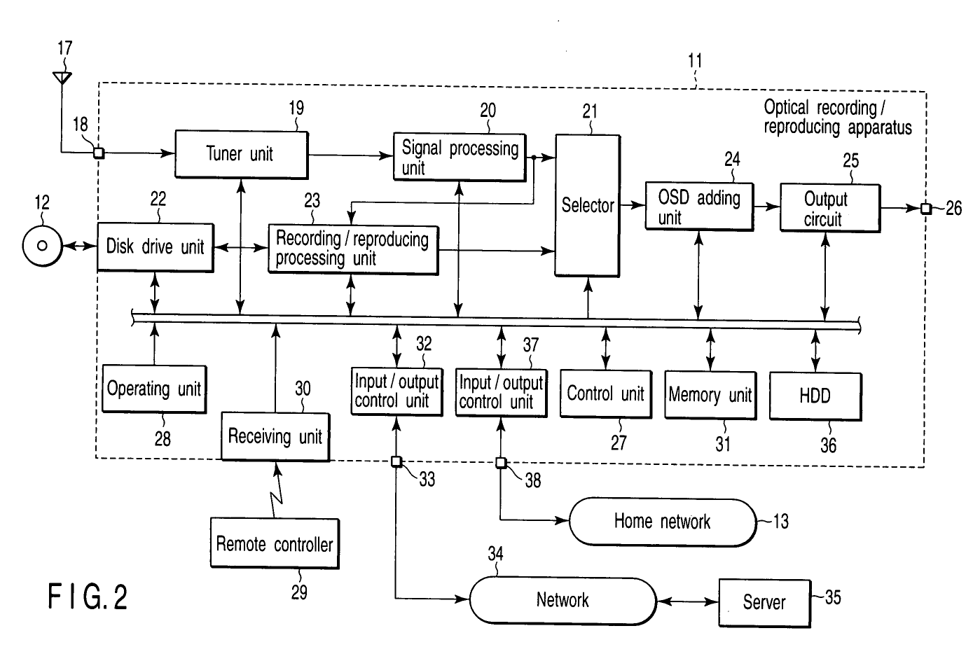

FIG. 2 shows a signal processing system of the optical disk recording/reproducing apparatus 11. First, the optical disk recording/reproducing apparatus 11 has a function of receiving television broadcasting. That is, television broadcasting signals received by an antenna 17 are supplied via an input terminal 18 to a tuner unit 19.

The tuner unit 19 selects broadcasting signals of a desired channel from input television broadcasting signals. The broadcasting signals selected by the tuner unit 19 are supplied to a signal processing unit 20. Then, the supplied signals are subjected to necessary processes including a demodulation process, a decoding process, and a decoding process, whereby the signals are restored to signals of video and audio (contents) and supplied to a selector 21.

The optical disk recording/reproducing apparatus 11 also has a disk drive unit 22 to which the optical disk 12 such as, for example, a DVD is loaded. When there is a request for reproducing to the optical disk 12, the disk drive unit 22 reads recorded data from the optical disk 12, and outputs the data to a recording/reproducing processing unit 23. At the time of reproduction to the optical disk 12, the recording/reproducing processing unit 23 performs a decoding process to input data, restores the decoded data to signals of video and audio (contents), and supplies the signals to the selector 21.

The selector 21 selects one of two kinds of contents input, and supplies the selected content to an on-screen display (OSD) adding unit 24. The OSD adding unit 24 adds a predetermined OSD signal to a video component of the input content. The content to which the OSD signal has been added in the OSD adding unit 24 is guided via an output circuit 25 and an output terminal 16 to the outside of the optical disk recording/reproducing apparatus 11.

Further, the contents of television broadcasting output from the signal processing unit 20 are supplied also to the recording/reproducing processing unit 23. When it is requested to record the contents obtained from television broadcasting to the optical disk 12, the contents supplied to the recording/reproducing processing unit 23 are encoded, output to the disk drive unit 22 and supplied for recording to the optical disk 12.

Herein, all the operations of the optical disk recording/reproducing apparatus 11 including the above-described recording/reproducing operations are totally controlled by a control unit 27. The control unit 27 has a central processing unit (CPU) and the like therein. The control unit 27 receives operation information from an operating unit 28, or operation information from a receiving unit 30 which receives signals sent from a remote controller 29, and controls the respective units so as to reflect the operation contents thereof.

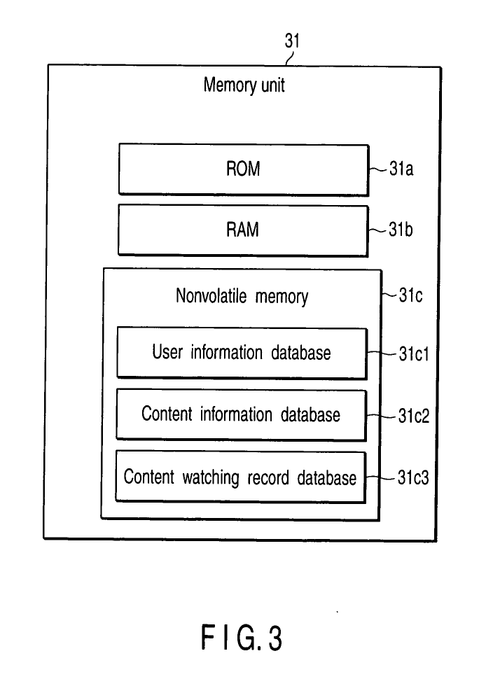

In this case, the control unit 27 uses a memory unit 31. The memory unit 31 has, as shown in FIG. 3, a read only memory (ROM) 31a having stored therein a control program executed by the CPU, a random access memory (RAM) 31b which provides a working area to the CPU, and a nonvolatile memory 31c which stores various kinds of setting information and control information, etc.

Further, the nonvolatile memory 31c has formed therein: a user information database 31c1 in which information concerning respective users who own the receiving terminals 14, 15, 16 have been recorded; a content information database 31c2 in information showing contents acquired by the optical recording/reproducing apparatus 11 from various media have been recorded; and a content watching record database 31c3 in which content watching records have been recorded per each of the respective users.

Reverting to FIG. 2, the control unit 27 is connected to an external network 34 via an input/output control unit 32 and an input/output terminal 33. The control unit 27 can access a desired server 35 via the network 34, and thereby acquire necessary contents.

The control unit 27 is also connected to a hard disk drive (HDD) 36 having a large recording capacity, and can record and reproduce contents acquired from various media including the optical disk 12, television broadcasting and the server 35 to and from the HDD 36.

Furthermore, the control unit 27 is connected to the home network 13 via an input/output control unit 37 and an input/output terminal 38, and can deliver contents acquired from various media including the optical disk 12, television broadcasting and the server 35 to the respective receiving terminals 14, 15, 16.

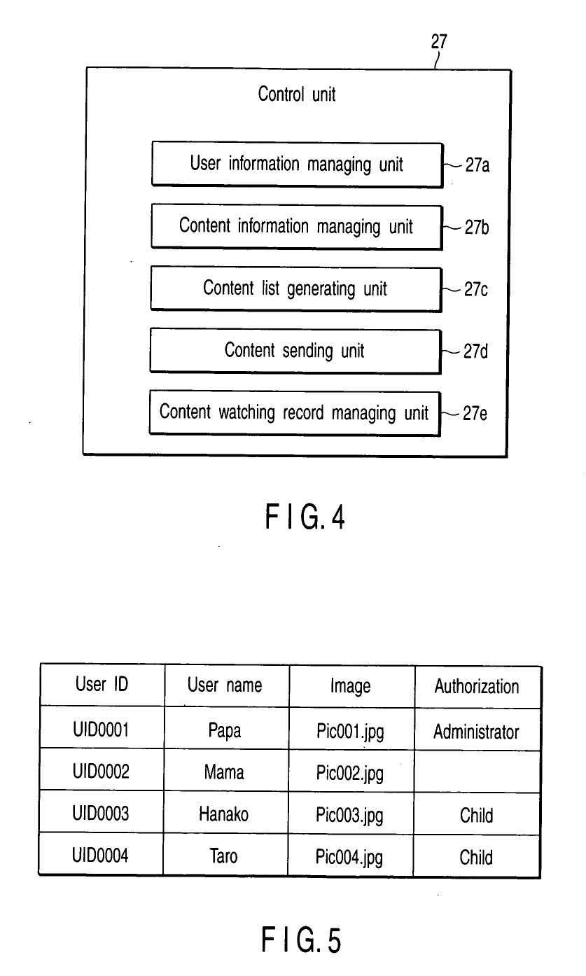

The control unit 27 has, as shown in FIG. 4, a user information managing unit 27a, a content information managing unit 27b, a content list generating unit 27c, a content sending unit 27d, and a content watching record managing unit 27e. The user information managing unit 27a manages the user information database 31c1. The content information managing unit 27b manages the content information database 31c2. The content list generating unit 27c generates a content list by use of the user information database 31c1, the content information database 31c2, and the content watching record database 31c3. The content sending unit 27d sends contents required by the users among the contents acquired from the various media to the respective receiving terminals 14, 15, 16. The content watching record managing unit 27e records content watching records to the content watching record database 31c3 on the basis of reproduction stop and delete instructions from the respective receiving terminals 14, 15, 16.

Herein, in the user information database 31c1, an user ID for identifying a user, a user name, image kinds, and watching authorization are corresponded with one another and recorded as shown in FIG. 5.

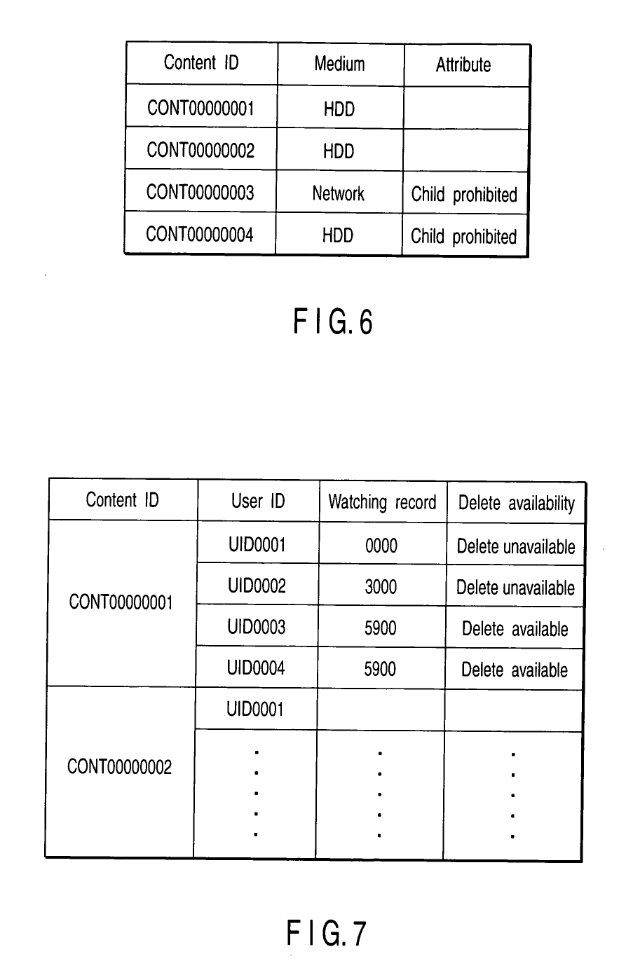

Further, in the content information database 31c2, a content ID as information for identifying a contents, a medium in which the content exists (to becomes a delivery source), and attributes added to the content are corresponded with one another and recorded as shown in FIG. 6.

Moreover, in the content watching record database 31c3, a content ID, a user ID, a watching record showing a lapse time of the content being watched, and delete availability to the content are corresponded with one another and recorded as shown in FIG. 7.

Among these, the watching record is a relative time from the content head at the stop of reproduction, and in the case of a content recorded in, for example, a DVD format, information of presentation time stamp (PTS) and the like may be employed.

In addition, the delete availability automatically sets a predetermined content before watching to “delete unavailable”, and automatically changes the predetermined content to “delete available” when there is an instruction for deleting a content from a user, or at completion of watching the content.

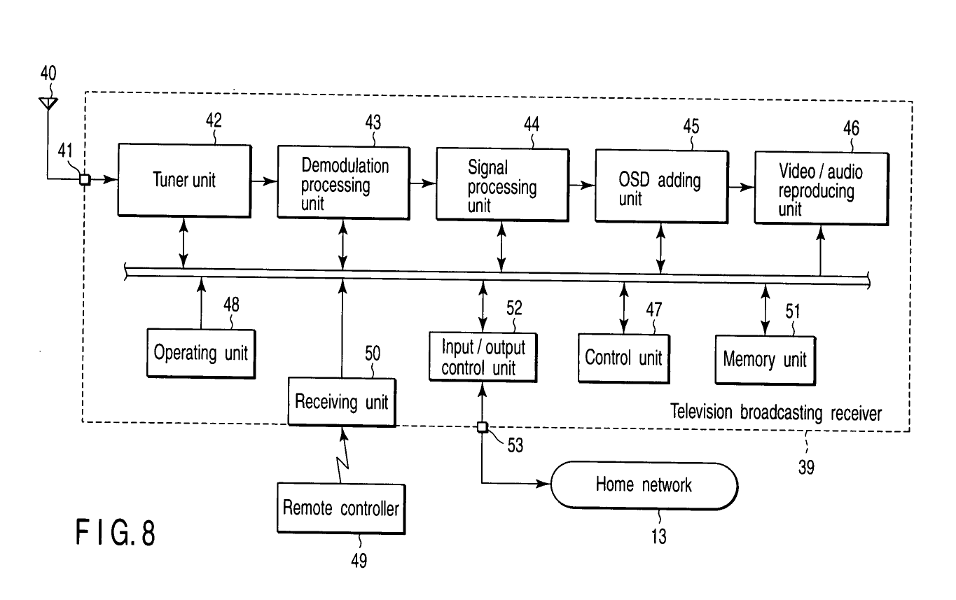

FIG. 8 shows a signal processing system of a television broadcasting receiver 39 used as the receiving terminals 14, 15, 16. More specifically, television broadcasting signals received by an antenna 40 are supplied via an input terminal 41 to a tuner unit 42.

The tuner unit 42 selects broadcasting signals of a desired channel from input television broadcasting signals. The broadcasting signals selected by the tuner unit 42 are supplied to a demodulation processing unit 43 and a signal processing unit 44, and thereby restored into signals of video and audio (contents).

After an OSD signal is added to video components of the contents output from this signal processing unit 44 by means of an OSD adding unit 45, the contents are supplied for video display and audio reproduction at requests from a video/audio reproducing unit 46.

Herein, all the operations of the television broadcasting receiver 39 including the above-described receiving operations are totally controlled by a control unit 47. The control unit 47 has a CPU and the like therein, and receives operation information from an operating unit 48, or operation information from a receiving unit 50 which receives signals sent from a remote controller 49, and controls the respective units so as to reflect the operation contents thereof.

In this case, the control unit 47 uses a memory unit 51. The memory unit 51 has a ROM having stored therein a control program executed by the CPU, a RAM which provides a working area to the CPU, and a nonvolatile memory which stores various kinds of setting information and control information, etc.

The control unit 47 is connected to the home network 13 via an input/output control unit 52 and an input/output terminal 53, and is configured to receive contents delivered by the optical disk recording/reproducing apparatus 11 to thereby perform video display and audio reproduction by the video/audio reproducing unit 46.

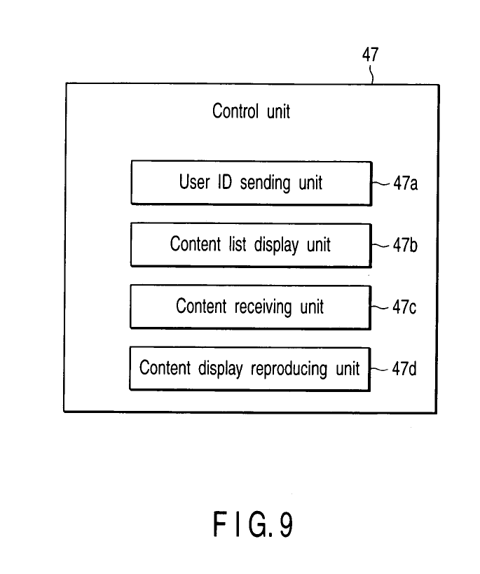

Herein, the control unit 47 has, as shown in FIG. 9, a user ID sending unit 47a, a content list display unit 47b, a content receiving unit 47c, and a content display reproducing unit 47b. The user ID sending unit 47a sends its own user ID to the optical disk recording/reproducing apparatus 11. The content list display unit 47b displays a content list sent from the optical disk recording/reproducing apparatus 11. The content receiving unit 47c receives contents sent from the optical disk recording/reproducing apparatus 11. The content display reproducing unit 47d performs the video display and audio reproduction of the received contents by means of the video/audio reproducing unit 46.

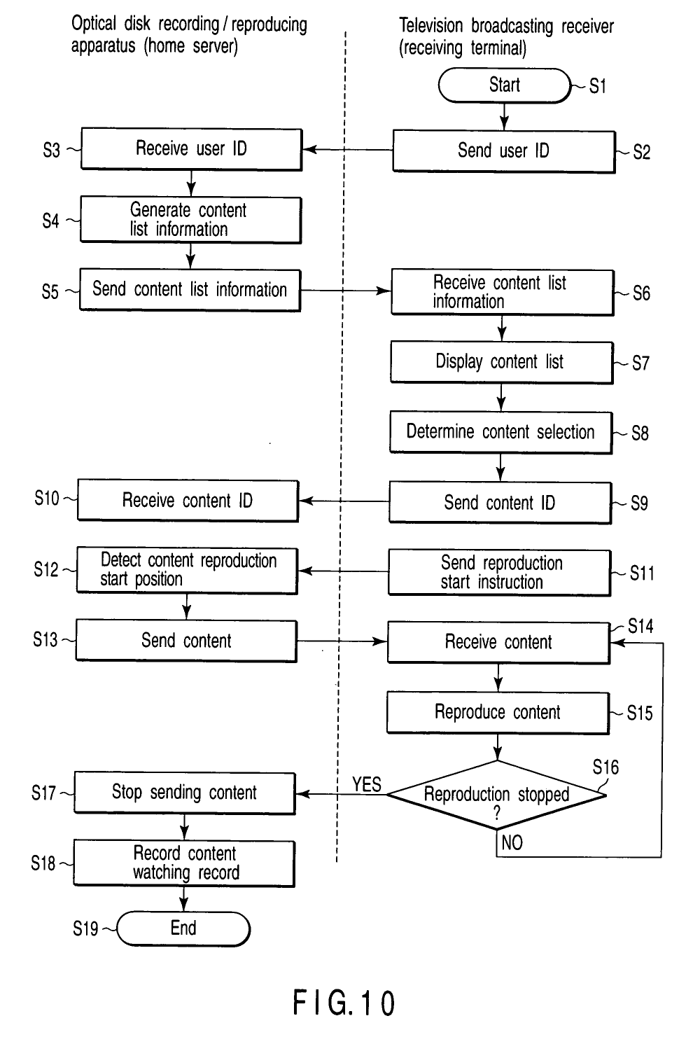

FIG. 10 shows a flow chart showing a processing operation in which, on the basis of a request of the television broadcasting receiver 39 as the receiving terminal 14, the optical disk recording/reproducing apparatus 11 as a home server delivers contents.

That is, when the process is started (block S1), the control unit 47 of the television broadcasting receiver 39, in block S2, sends a user ID to the optical disk recording/reproducing apparatus 11 on the basis of a user's operation.

The operation in block S2 is made in such a manner that, for example, when a user turns on the television broadcasting receiver 39, the control unit 47 automatically displays a user ID selection screen on the video/audio reproducing unit 46 on the basis of user information registered in advance, and the user selects and determines its own user ID on the user ID selection screen.

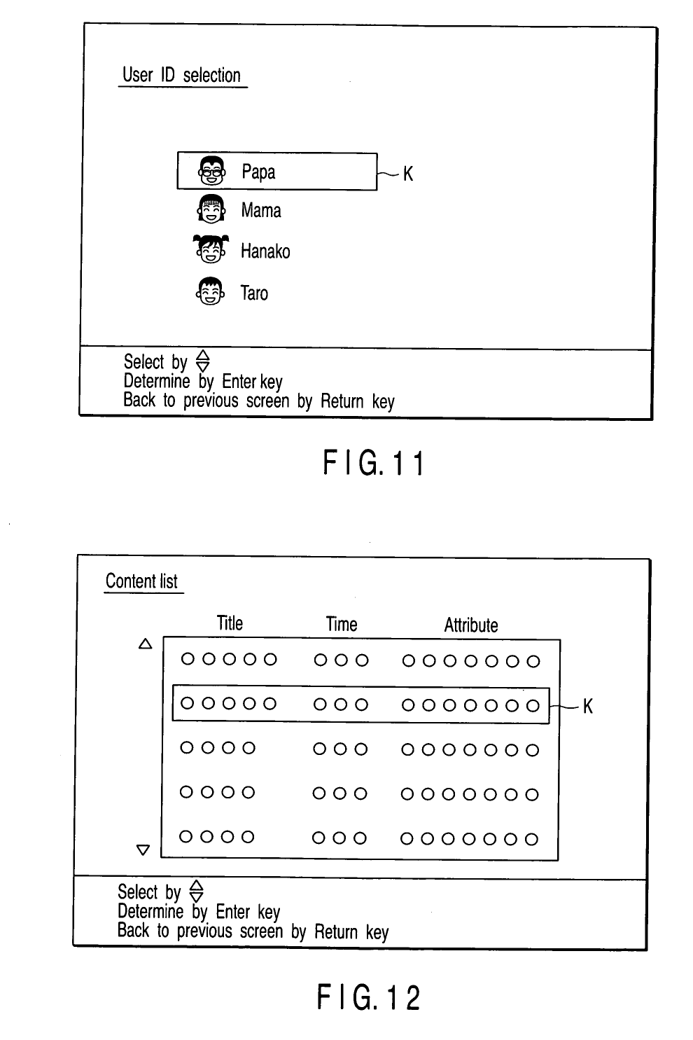

More specifically, in the user ID selection screen, as shown in FIG. 11, items showing four users including “Papa”, “Mama”, “Hanako” and “Taro” registered in advance are displayed. When a cursor key of the remote controller 49 is operated to move a cursor K, a desired user is selected, and the enter key is operated, whereby the user ID of the determined user is sent to the optical disk recording/reproducing apparatus 11.

Then, the control unit 27 of the optical disk recording/reproducing apparatus 11 receives the user ID in block S3. In block S4, on the basis of the received user ID, the control unit 27 refers to the user information database 31c1, the content information database 31c2 and the content watching record database 31c3, and automatically searches for contents whose watching is permitted for the user ID, thereby generating content list information.

For example, when the user ID is “UID0003”, the authorization is “Child”. Accordingly, contents having content IDs of “CONT00000003” and “CONT00000004” whose attribute is “Child Prohibited” are controlled so as not to be included in the content list.

Further, contents having content ID of “CONT00000001” are “delete available” to users whose user IDs are “IID0003” and “UID0004”. Accordingly, contents having the content ID of “CONT00000001” are controlled so as not to be included in the content list to the users whose user IDs are “UID0003” and “UID0004”.

In block S5, the control unit 27 of the optical disk recording/reproducing apparatus 11 sends the generated content list information to the television broadcasting receiver 39.

Then, the control unit 47 of the television broadcasting receiver 39 receives the content list information in block S6, and generates a content list and displays it on the video/audio reproducing unit 46 in block S7. The content list, as shown in FIG. 12, displays titles, time instants and attributes of contents in a list format. The contents that cannot be displayed thereon can be displayed by operating the cursor key of the remote controller 49 to scroll contents upward or downward.

Further, on the content list screen, by operating the cursor key of the remote controller 49 to move the cursor K, a desired content is selected, and by operating the enter key, the content can be selectively determined.

When the control unit 47 of the television broadcasting receiver 39 detects that a predetermined content has been selected and determined on the content list screen in block S8, the control unit sends the content ID of the selected and determined content to the optical recording/reproducing apparatus 11 in block S9.

Then, the control unit 27 of the optical recording/reproducing apparatus 11 receives the content ID and gets into its waiting state in block S10.

Thereafter, when the user operates the remote controller 49 of the television broadcasting receiver 39 to request for the start of reproducing the content, the control unit 47 of the television broadcasting receiver 39 sends a reproduction start instruction to the optical recording/reproducing apparatus 11 in block S11.

The control unit 27 of the optical recording/reproducing apparatus 11 receives the reproduction start instruction, and then, in block S12, the control unit 27 refers to the content watching record database 31c3, and detects a reproduction start position of the user who has requested for reproduction (user ID received in block S3) to the content requested to be reproduced (content ID received in block S10).

Thereafter, the control unit 27 of the optical recording/reproducing apparatus 11, in block 13, reads, from the reproduction start position detected previously, the content from a medium in which the content requested to be reproduced exists, performs a decoding process on a content which are not decoded, and sends the content to the television broadcasting receiver 39.

Then, the control unit 47 of the television broadcasting receiver 39 receives the contents in block S14, and performs the video display and the audio reproduction of the content by the video/audio reproducing unit 46 in block S15.

Thereafter, in block S16, the control unit 47 of the television broadcasting receiver 39 determines whether or not the user has operated the remote controller 49 to request for the stop of reproduction of the content. When it is determined that the reproduction stop has not been requested (NO), the control unit is returned to the process in block S14, and the reproduction of the content is continued.

When it is determined that the reproduction stop has been requested in block S16 (YES), the control unit 47 of the television broadcasting receiver 39 sends the reproduction stop instruction to the optical recording/reproducing apparatus 11.

When the control unit 27 of the optical recording/reproducing apparatus 11 receives the reproduction stop instruction, the control unit 27 stops sending the content in block S17, writes information showing the send stop position (reproduction stop position) of the contents into the content watching record database 31c3 in block S18, and completes the process (block S19).

According to the embodiment described above, a home network system is configured such that the optical recording/reproducing apparatus 11 serving as a home server manages contents obtained from various kinds of media individually for each of users. Consequently, it is possible to respond to various requests from each of users at a practical level, such as each user resuming watching from the position of the previous watching end even to a same content.

Further, as shown in FIG. 11, a face image of each user is displayed on the user ID selection screen, it whereby is possible to improve the usability for the user as a home network system.

Furthermore, since information showing watching authorization per user is added to the user information database 31c1 shown in FIG. 5, and information showing attributes per user is added to the content information database 31c2 shown in FIG. 6, it is possible to control accessibility of each user to each content. In the examples in FIGS. 5 and 6, a parental control for prohibiting only children from watching contents is easily realized. In the same manner, it is possible to hold own contents whose watching is available exclusively for a predetermined user.

Moreover, for example in the case of contents recorded in the HDD 36, there may be added a function of deleting substances of the contents automatically when all the users who have accessibility to the contents have completed watching, or when all the users who have accessibility to the contents instruct to delete the contents.

Further, by adding a function of setting “delete unavailable (permanent preservation)” to the attributes of the content information database 31c2 shown in FIG. 6, or by adding a function of asking a user whether or not to change the setting to “delete available” at completion of watching in setting delete unavailable to the content watching record database 31c3 shown in FIG. 7, it is possible to prevent contents themselves from being deleted automatically, and keep a predetermined content permanently.

In addition, switching users is not limited to the operation on the user ID selection screen shown in FIG. 11, but it may be automatically determined by use of a personal cellular phone or peculiar remote controller. Alternatively, a key for user selection may be added to the remote controller.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information management apparatus comprising:
a recording unit configured to record a database in which user identification information, content identification information and content watching record information are corresponded to one another;
a content list sending unit configured to search for contents corresponding to the user identification information input via a network from the database recorded by the recording unit, generate information showing a list of searched contents, and send the information to the network;
a content sending unit configured to, when a request for reproducing the content selected from the information sent by the content list sending unit is input via the network, send the content to the network from a position shown in the content watching record information of the database; and
a control unit configured to, when a content send stop is requested via the network in a state in which a content is sent by the content sending unit, stop sending the content, and record a send stop position of the content to the content watching record information of the database.

2. An information management apparatus according to claim 1, wherein
the recording unit is configured to record:
a user information database in which the user identification information and a user name are corresponded to each other;
a content information database in which the content identification information and information showing a medium wherein a content shown by the content identification information exists are corresponded to each other; and
a content watching record database in which the user identification information, the content identification information and the content watching record information are corresponded to one another.

3. An information management apparatus according to claim 2, wherein
the user information database records information showing watching authorization in correspondence to the user identification information, and
the content information database records attribute information showing watching availability of contents to the watching authorization in correspondence to the user identification information.

4. An information management apparatus according to claim 3, wherein
the content list sending unit is configured so that a content having watching authorization to which the attribute information of the content information database shows watching unavailable is not contained in the content list.

5. An information management apparatus according to claim 2, wherein
the content watching record database records information showing delete availability of contents in correspondence to the user identification information.

6. An information management apparatus according to claim 5, wherein
the content list sending unit is configured so that a content to which the information showing delete availability of the content watching record database shows delete available is not contained in the content list.

7. An information management apparatus according to claim 5, wherein
the information showing delete availability of the content watching record database is set to delete unavailable before watching the content, and is automatically changed into delete available when there is an instruction for deleting the content, or at completion of watching the content.

8. An information management method comprising:
a first block of recording a database in which user identification information, content identification information and content watching record information are corresponded to one another;
a second block of searching for contents corresponding to the user identification information input via a network from the database recorded in the first block, generating information showing a list of searched contents, and sending the information to the network;
a third block of, when a request for reproducing the content selected from the information sent in the second block is input via the network, sending the content to the network from a position shown in the content watching record information of the database; and
a fourth block of, when a content send stop is requested via the network in a state of a content is sent in the third block, stopping sending the content, and recording a send stop position of the content to the content watching record information of the database.

9. An information management method according to claim 8, wherein
the first block records:
a user information database in which the user identification information and a user name are corresponded to each other;
a content information database in which the content identification information and information showing a medium wherein the content shown by the content identification information exists are corresponded to each other; and
a content watching record database in which the user identification information, the content identification information and the content watching record information are corresponded to one another.

10. An information management method according to claim 9, wherein
the user information database records information showing watching authorization in correspondence to the user identification information, and
the content information database records attribute information showing watching availability of contents to the watching authorization in correspondence to the user identification information.

11. An information management method according to claim 10, wherein
the second block does not contain a content having watching authorization to which the attribute information of the content information database shows watching unavailable in the content list.

12. An information management method according to claim 9, wherein
the content watching record database records information showing delete availability of contents in correspondence to the user identification information.

13. An information management method according to claim 12, wherein
the second block does not contain a content to which the information showing delete availability of the content watching record database shows delete available in the content list.

14. An information management method according to claim 12, wherein
the information showing delete availability of the content watching record database is set to delete unavailable before watching the content, and is automatically changed into delete available when there is an instruction for deleting the content, or at completion of watching the content.

15. A content delivery system having a database in which user identification information, content identification information and content watching record information are corresponded to one another, and having a server device which sends contents to a network, and a plurality of receiving terminals which reproduce contents sent from the server device via the network, the content delivery system comprising:
a user identification information sending unit configured to send predetermined user identification information from the receiving terminals to the network;
a content list sending unit configured to cause the server device to: search for contents corresponding to the user identification information sent to the network by the user identification information sending unit from the database; and generate information showing a list of searched contents; and send the information to the network;
a reproduction request sending unit configured to: cause the receiving terminals to display a content list on the basis of the information sent by the content list sending unit; select a desired content from the displayed content list; and send the reproduction request to the network;
a content sending unit configured to cause the server device to send the content corresponding to the reproduction request sent to the network by the reproduction request sending units from a position shown in the content watching record information of the database to the network;
a send stop requesting unit configured to cause the receiving terminals to request a stop of sending contents via the network in a state in which a content is send by the content sending unit; and
a control unit configured to cause the server device to: stop sending the contents on the basis of the send stop request by the send stop requesting unit; and record a send stop position of the content to the content watching record information of the database.
